(19) United States
(12) Patent Application Publication
(10) Pub. No.: US 2025/0003092 A1
(43) Pub. Date: Jan. 2, 2025

(54) MULTI-LAYERED MEMBRANES FOR ELECTROCHEMICAL CELLS

(71) Applicant: ELECTRIC HYDROGEN CO., Natick, MA (US)

(72) Inventors: Syed Dawar SAJJAD, Boston, MA (US); Danielle GOBRON, Arlington, MA (US); Timothy J. KUCHARSKI, Belmont, MA (US); Jigish TRIVEDI, Pleasanton, CA (US)

(21) Appl. No.: 18/703,584

(22) PCT Filed: Dec. 21, 2022
(86) PCT No.: PCT/US2022/053623

§ 371 Date: Apr. 22, 2024

Related U.S. Application Data
(60) Provisional application No. 63/293,984, filed on Dec. 27, 2021.

(51) Int. Cl. C25B 13/02; C25B 9/23; C25B 11/032; C25B 11/079; C25B 11/081

(52) U.S. Cl. CPC C25B 13/02; C25B 9/23; C25B 11/032; C25B 11/079; C25B 11/081

(57) ABSTRACT

The following disclosure relates to multi-layered membranes for electrochemical cells. The multi-layered membranes include a first membrane layer, a second membrane layer, and a coating composition positioned between the first membrane layer and the second membrane layer. Wherein the multi-layered membrane comprises a radical scavenger composition or a hydrogen crossover mitigation catalyst within the first membrane layer, the second membrane layer, or a coating composition positioned between the first membrane layer and the second membrane layer.

This application claims the benefit of U.S. Provisional Patent Application No. 63/293,984, filed Dec. 27, 2021, which is hereby incorporated by reference in its entirety.

### FIELD

The following disclosure relates to membranes for electrochemical cells. Specifically, the disclosure relates to multi-layered membranes, which, in certain examples, have an intermediate coating material or coating layer positioned between two adjacent membrane layers of a multi-layered membrane.

### BACKGROUND

An electrochemical or electrolysis cell or system uses electrical energy to drive a chemical reaction. For example, within a water splitting electrolysis reaction within the electrolysis cell, water is split to form hydrogen and oxygen. The products may be used as energy sources for later use. In recent years, improvements in operational efficiency have made electrolyzer systems competitive market solutions for energy storage, generation, and/or transport. For example, the cost of generation may be below $10 per kilogram of hydrogen in some cases. Increases in efficiency and/or improvements in operation will continue to drive installation of electrolyzer systems.

Various challenges are present with operation at the membrane of an electrolysis cell. These challenges are not well described within the literature and are not fully appreciated in the field.

For example, ion exchange membrane (IEM) performance may be related to the thickness of the membrane. That is, a thinner membrane will conduct more protons/current at a given overpotential. However, very thin membranes are problematic because of their rapid loss of mechanical and chemical integrity due to degradation during operation. Additionally, thin membranes may present challenges with an increased risk of crossover of hydrogen from the cathode (H₂) side to the anode (O₂) side.

It is specifically desired to develop improved membranes for electrochemical cells that will meet performance requirements (e.g., thin membranes with improved mechanical and chemical integrity).

### SUMMARY

In one embodiment, a multi-layered membrane for an electrochemical cell is provided. The multi-layered membrane includes a first membrane layer and a second membrane layer. Further, the multi-layered membrane includes a radical scavenger composition and/or a hydrogen crossover mitigation catalyst within the first membrane layer, the second membrane layer, and/or a coating composition positioned between the first membrane layer and the second membrane layer.

In another embodiment, an electrochemical cell is provided. The cell includes an anode flow field, a cathode flow field, and a multi-layered membrane positioned between the anode flow field and the cathode flow field. The multi-layered membrane includes a first membrane layer and a second membrane layer, wherein the multi-layered membrane includes a radical scavenger composition and/or a hydrogen crossover mitigation catalyst within the first membrane layer, the second membrane layer, and/or a coating composition positioned between the first membrane layer and the second membrane layer.

In another embodiment, a method of forming a multi-layered membrane is provided. The method includes providing a first membrane layer, adding a coating composition to a surface of the first membrane layer, and adding a second membrane layer to the coating composition such that the coating composition is positioned between the first membrane layer and the second membrane layer.

In another embodiment, a method of forming a multi-layered membrane is provided. The method includes providing a first membrane layer and casting or depositing a second membrane composition onto a surface of the first membrane layer to form a second membrane layer adjacent to the first membrane layer, wherein the first membrane layer and the second membrane layer comprise different compositions, and wherein the second membrane layer comprises radical scavenger composition and/or a hydrogen crossover mitigation catalyst.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Exemplary embodiments are described herein with reference to the following drawings.

FIG. 1 depicts an example of an electrolytic cell.

FIG. 2 depicts an example of a multi-layered membrane in an electrolytic cell.

FIGS. 3A, 3B, and 3C depict cross-sectional views of an example of an electrochemical cell with a limited number of flow channels of the flow fields depicted for clarity.

FIG. 4 depicts an additional example of a multi-layered membrane in an electrolytic cell.

FIG. 5 depicts an additional example of a multi-layered membrane in an electrolytic cell.

FIG. 6 depicts an example of an arrangement wherein the overall membrane includes two membrane layers with a coating positioned between the two layers to provide a peak concentration for the selected agent of the coating.

FIG. 7 depicts an example of an arrangement providing a step function in concentration between the two membrane layers of an overall membrane.

While the disclosed compositions and methods are representative of embodiments in various forms, specific embodiments are illustrated in the drawings (and are hereafter described), with the understanding that the disclosure is intended to be illustrative and is not intended to limit the claim scope to the specific embodiments described and illustrated herein.

### DETAILED DESCRIPTION

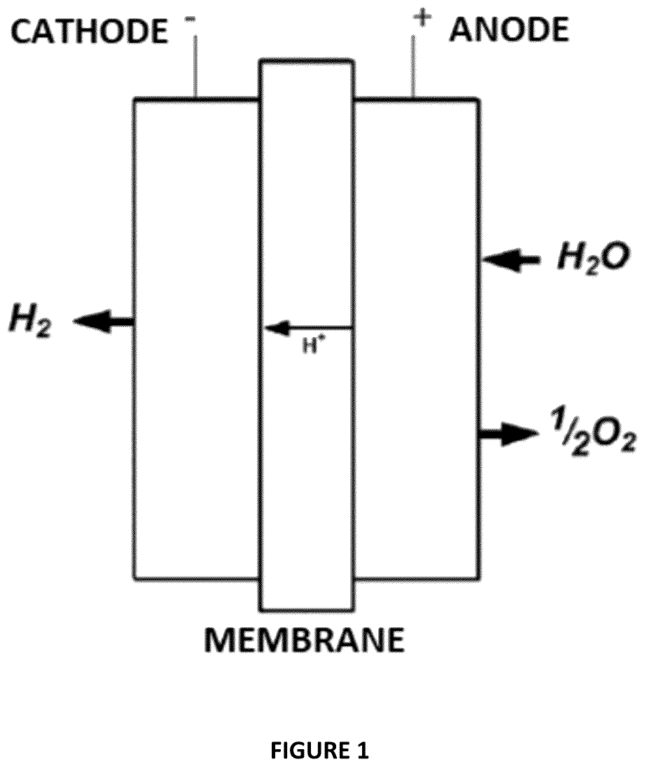

FIG. 1 depicts an example of an electrolytic cell for the production of hydrogen gas and oxygen gas through the splitting of water. The electrolytic cell includes a cathode, an anode, and a membrane positioned between the cathode and anode. Within the water splitting electrolysis reaction, one interface runs an oxygen evolution reaction (OER) while the other interface runs a hydrogen evolution reaction (HER). For example, the anode reaction is H₂O→2H⁺+½O₂+2e and the cathode reaction is 2H⁺+2e→H₂. The water electrolysis reaction has recently assumed great importance and renewed attention as a potential foundation for a decarbonized “hydrogen economy.”

As noted above, challenges are present for developing a thin membrane for an electrochemical cell that has improved mechanical and chemical integrity (e.g., does not degrade as quickly during operation of the electrochemical cell and prevents hydrogen crossover from the cathode (H₂) side to the anode (O₂) side of the cell).

A solution for an improved membrane for the electrochemical cell may be achieved through the formation of a multi-layered membrane having at least two membrane layers, e.g., with a coating composition positioned between the two layers.

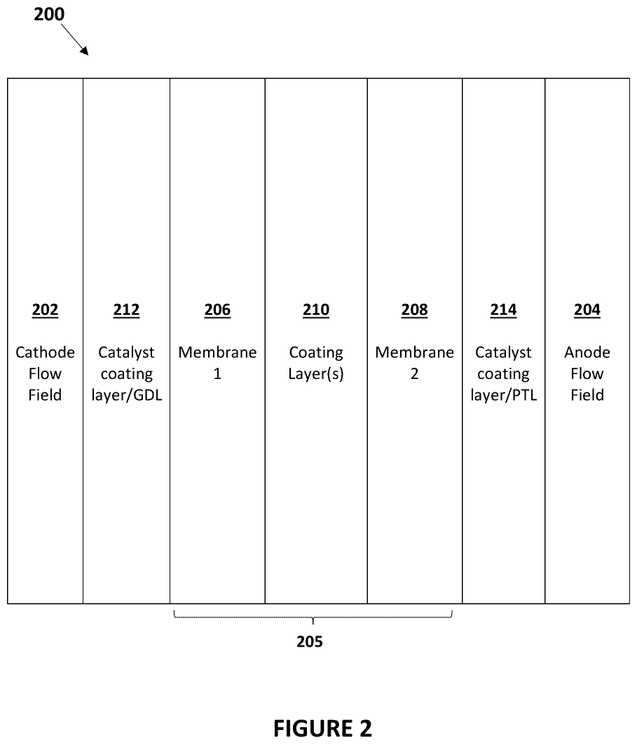

FIG. 2 depicts an example of such an arrangement for an improved membrane within an electrochemical cell. Specifically, FIG. 2 depicts a portion of an electrochemical cell 200 having a cathode flow field 202, an anode flow field 204, and a multi-layered membrane 205 positioned between the cathode flow field 202 and the anode flow field 204.

In this particular example, the multi-layered membrane 205 includes a first membrane layer 206 positioned adjacent to the cathode flow field 202, a second membrane layer 208 positioned adjacent to the anode flow field 204, and at least one coating layer 210 positioned between the first membrane layer 206 and the second membrane layer 208. In certain examples, the multi-layered membrane 205 may have an overall thickness of the multiple membrane layers (e.g., the first and second membrane) as well as any intermediate/coating layer between membrane layers of the multiple membrane layers that is less than 1000 microns, less than 500 microns, less than 100 microns, less than 50 microns, less than 10 microns, less than 5 microns, less than 2 microns, or less than 1 micron. In other examples, the multi-layered membrane 205 may have an overall thickness of the multiple membrane layers and any intermediate layers between adjacent membrane layers of the multi-layered membrane that is in a range of 1-1000 microns, in a range of 2-500 microns, in a range of 5-100 microns, or in a range of 10-50 microns.

As discussed in greater detail below, the at least one coating layer 210 may include at least one agent or catalyst that is configured to aid in extending the life of the multi-layered membrane 205 and/or provide an added level of protection during operation of the electrochemical cell.

In certain examples, additional layers may be present within the electrochemical cell 200. For example, one or more additional layers 212 may be positioned between the cathode flow field 202 and first membrane layer 206. In certain examples, this may include a cathode catalyst coating layer. Additionally, or alternatively, a gas diffusion layer (GDL) may be positioned between the cathode flow field 202 and first membrane layer 206. This may be advantageous in providing a hydrogen diffusion barrier adjacent to the cathode on one side of the multi-layered membrane to mitigate hydrogen crossover to the anode side. In some examples, a cathode catalyst coating layer may be positioned between the cathode flow field 202 and the GDL.

Similarly, one or more additional layers 214 may be present in the electrochemical cell between the second membrane layer 208 and the anode flow field 204. In certain examples, this may include an anode catalyst coating layer. Additionally, or alternatively, a porous transport layer (PTL) may be positioned between the second membrane layer 208 and the anode flow field 204. In some examples, an anode catalyst coating layer may be positioned between the anode flow field 204 and the PTL.

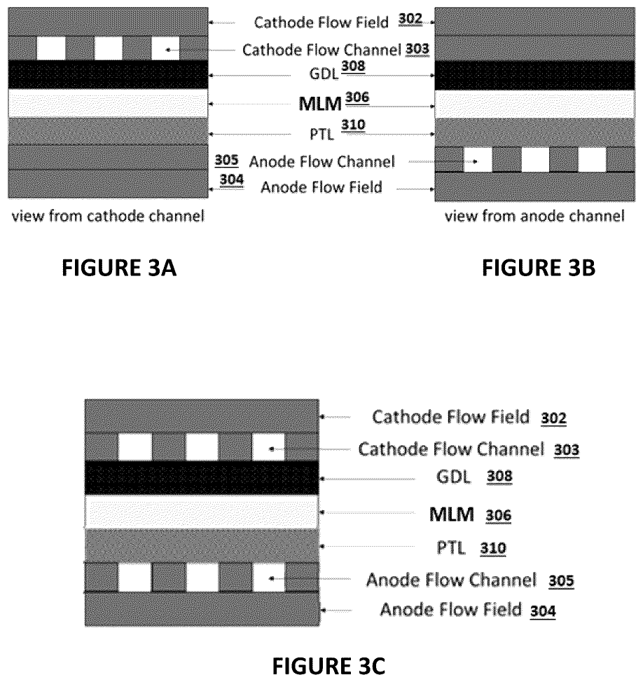

FIGS. 3A, 3B, and 3C depict an additional example of a multi-layered membrane for further clarification. In these particular examples, the electrochemical cell includes a cathode flow field 302, cathode flow channels 303, an anode flow field 304, anode flow channels 305, and a multi-layered membrane (MLM) 306 positioned between the cathode and the anode. (While the MLM 306 is depicted as a single layer for clarity, the example incorporates multiple layers, such as the example in FIG. 2, as well as the additional examples further described herein.) Additionally, the electrochemical cell 300 includes a gas diffusion layer 308 positioned between the multi-layered membrane 306 and the cathode flow channels 303. Further, a porous transport layer 310 is positioned between the multi-layered membrane 306 and the anode flow channels 305.

In the particular example depicted in FIGS. 3A and 3B, the cathode and anode flow fields are arranged to provide a cross-fluid flow. In such a cross-fluid arrangement, the fluid flow through the cathode flow channels is arranged perpendicular to the fluid flow through the anode flow channels. Specifically, FIG. 3A depicts the cross-sectional view of the electrochemical cell with the cathode flow channels displayed, while FIG. 3B depicts the cross-sectional view of the electrochemical cell rotated 90 degrees to display the anode flow channels.

In alternative examples, the flow fields may have a co-flow configuration or a counter-flow configuration. FIG. 3C depicts an alternative example, wherein the channels and lands of the anode flow field are parallel with the channels and lands of the cathode flow field. With the parallel arrangement, in a co-flow configuration, the flow of fluid through the anode flow field channels is in the same direction as the flow of fluid through the cathode flow field channels. Alternatively, a counter-flow configuration may be present with the parallel arrangement of the anode and cathode flow fields, wherein the flow of fluid through the anode flow field channels is in an opposite direction as the flow of fluid through the cathode flow field channels.

The orientation or configuration of fluid flow between the anode flow field and cathode flow field may be advantageous in adjusting or controlling the pressure distribution or temperature distribution within the electrochemical cell.

Regarding these anode and cathode flow fields depicted in FIGS. 3A and 3B, such flow fields may be configured to have paths of channels and land. The channels are configured for directing the flow of water and gas, while the lands are configured to contact an adjacent layer of the electrochemical cell (e.g., the GDL or PTL) providing electrical contact. FIGS. 3A and 3B depict examples of cells having three cathode flow channels and three anode flow channels, respectively. The number of flow channels are depicted for simplicity of a design, and in potential commercial use, may include many more flow channels. As such, the disclosure is not limited to such configurations as depicted in FIGS. 3A and 3B.

The multi-layered membrane disclosed herein may be advantageous in providing a concentration profile that has a peak in a concentration of a selected agent or catalyst within the middle or near the center of the multi-layered membrane (e.g., within the coating layer between the two membrane layers). Additionally, or alternatively, the multi-layered membrane may be advantageous in providing a configuration where the agent or catalyst is protected by the adjacent membrane layers, such that the agent/catalyst is not directly exposed to reactant components on either outer surface of the membrane at the anode or cathode. In other words, the coating on one starting layer may be used to produce a peak in the concentration of a selected agent that is removed from either surface.

Another advantage of the multi-layered membrane is that its design may allow for the addition of a compositions with desirable transport properties but challenging mechanical properties. That is, the multi-layered membrane design may allow for the addition of an internal (e.g., coating) layer positioned between two adjacent membrane layers. The internal/coating layer includes the desirable properties but inadequate mechanical properties that are supported and strengthened by the surrounding membrane layers such that the overall multi-layered membrane is mechanically sound for inclusion within the electrochemical cell.

One particular example of such a multi-layered membrane may include several ion-exchange materials that have been developed in research laboratories that have good hydrogen ion diffusion and hydrogen-blocking properties but cannot meet the mechanical integrity requirements or reliability. These materials could be combined within a multi-layered membrane with a proven material that already meets the mechanical requirements.

Another example may be a composite membrane in which a particulate phase is incorporated into one or more membrane in order to decrease the rate of transport of molecular hydrogen while leaving the transport of protons largely unchanged, where the particulate phase could be a hydrogen-storage materials such as a MOF (metal organic framework).

In certain examples, the agent or catalyst within the coating layer may include a radical scavenger composition. Such a radical scavenger composition may be configured to reduce radical damage and extend the life of the membrane. This is advantageous because ion exchange membranes (e.g., proton exchange membranes) in water electrolysis may degrade over time from the presence of radicals within the oxygen evolution reaction. Therefore, radical scavengers may be introduced or added to a membrane composition in order to reduce such radical damage.

Further, by positioning the radical scavenger composition within a coating layer between two membrane layers, this may be advantageous in improving the lifetime of the ion-exchange membrane through a reduction in degradation from the radical formation, while being separated from both the cathode and anode interfaces by at least one membrane layer, therein minimizing undesired interactions or restrictions in the promotion of the oxygen evolution reaction at the anode or the hydrogen evolution reaction at the cathode.

In certain examples, the radical scavenger composition may include catalytic nanoparticles. The catalytic nanoparticles may be cerium oxide, manganese oxide, or combinations thereof. In other examples, the radical scavenger composition may be an organic compound such as terephthalic acid, A-tocopherol, phenolic antioxidants, or combinations thereof.

Additionally, or alternatively to radical scavenger compositions, the agent or catalyst within the coating layer between the two membrane layers may include a hydrogen-crossover mitigation agent or catalyst configured to minimize hydrogen crossover from the hydrogen side (cathode side) of the cell to the oxygen side (anode side) of the cell. Hydrogen cross-over is a potentially hazardous condition that occurs due to normal molecular diffusion processes, but which becomes highly problematic when the membrane becomes very thin. Therefore, adding a catalyst to a thin membrane within an electrolytic cell to catalyze a reaction with hydrogen prior to its migration or crossover to the oxygen side (anode side) of the cell may be desirable.

In certain examples, the agent or catalyst within the coating layer may include platinum, which rapidly catalyzes the reaction of any hydrogen present. Again, the positioning of the catalyst within a coating composition layer between two membrane layers is advantageous in providing a separation between the catalyst and the anode or cathode. This allows for the catalyst to catalyze any hydrogen present prior to crossover from the hydrogen side to the oxygen side of the cell while minimizing undesired interactions or restrictions in the promotion of the oxygen evolution reaction at the anode or the hydrogen evolution reaction at the cathode.

The number of coating layers between the two adjacent membranes may vary based on the types of properties targeted within the multi-layered membrane. For example, the multi-layered membrane may include multiple coating layers between the adjacent membrane layers, wherein a first coating layer includes a radical scavenger composition, and a second coating layer includes a hydrogen-crossover mitigation catalyst. Further coating layers may be present to aid in providing additional membrane performance properties. Alternatively, the multi-layered membrane may include a single coating layer between the two membrane layers that contains all of the desired membrane performance properties (e.g., the radical scavenger composition and the hydrogen-crossover mitigation catalyst).

In certain examples, the combination of multiple membranes and at least one catalyst coating layer positioned between the membranes may be advantageous in providing specific performance properties that are different within the center or bulk of the membrane in comparison to on an outer surface of the membrane near one of the electrodes. For example, the multi-layered membrane may be configured with the internal coating layer to provide that the local pH within the center of the membrane is different from the pH at an outer surface such that a low pH within the center or bulk of the membrane supports rapid proton transport but a higher pH at the outer surface (e.g. near the anode) mitigates against corrosion of the metals and/or catalysts at the outer surface.

Regarding the multiple membrane layers within the multi-layered membrane, the first membrane layer may be the same membrane composition as the second membrane layer. Alternatively, the first membrane layer may have a different composition.

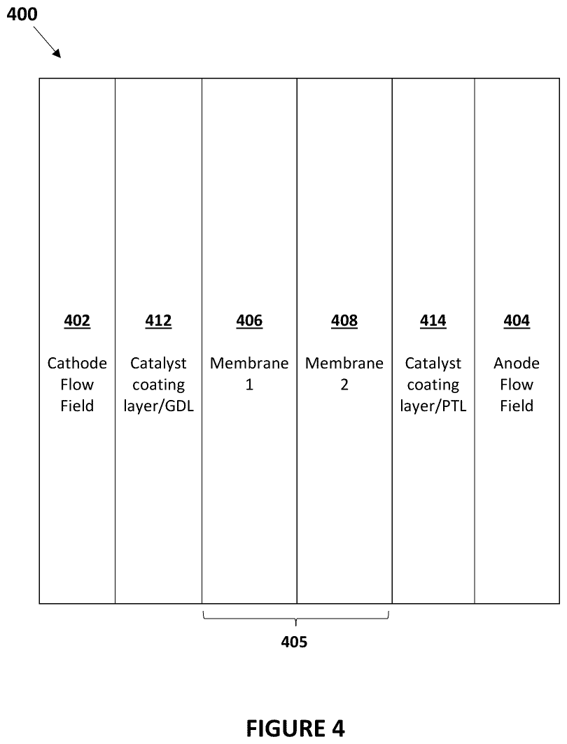

FIG. 4 depicts an alternative example of a multi-layered membrane. In this example, an electrochemical cell 400 is provided, wherein the cell 400 includes a cathode flow field 402, an anode flow field 404, and a multi-layered membrane 405 positioned between the cathode flow field 402 and the anode flow field 404.

In this particular example, the multi-layered membrane 405 includes a first membrane layer 406 positioned adjacent to the cathode flow field 402, a second membrane layer 408 positioned adjacent to the anode flow field 404. The first membrane layer 406 and the second membrane layer 408 have different compositions/components within each layer.

Similar to the example in FIG. 2, a catalyst coating layer and/or GDL 412 may be positioned between the cathode flow field 402 and first membrane layer 406. Additionally, a catalyst coating layer and/or PTL 414 may be positioned between the second membrane layer 408 and anode flow field 404.

In contrast with the example in FIG. 2, this particular multi-layered membrane 405 does not include an intermediate coating layer positioned between the first membrane layer 406 and the second membrane layer 408. Instead, the performance properties advantageously present in the coating layer described above are instead included within one of the two membrane layers of the multi-layered membrane 305.

For example, a radical scavenger composition and/or hydrogen-crossover mitigation agent as described above may be positioned within one of the two membranes to reduce radical damage/extend the life of the membrane or minimize hydrogen crossover, respectively. As noted above, inclusion of such agents or compositions near the surface of the cathode or anode may adversely affect the hydrogen evolution reaction or oxygen evolution reaction. As such, placement of the agent or composition within one of the two membranes effectively removes the agent or composition from one of the electrodes. For example, an agent or composition positioned within the first membrane layer 406 is effectively removed from direct interaction with the anode flow field 404 (as the second membrane 408 provides a buffer between the two layers). Similarly, an agent or composition positioned within the second membrane layer 408 is effectively removed from direct interaction with the cathode flow field 402.

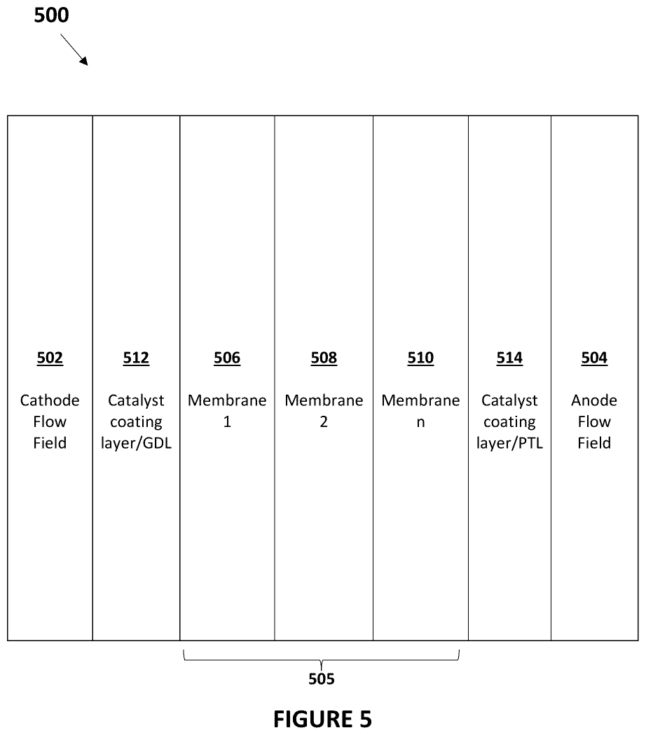

FIG. 5 depicts an alternative example of a multi-layered membrane. In this example, an electrochemical cell 500 is provided, wherein the cell 500 includes a cathode flow field 502, an anode flow field 504, and a multi-layered membrane 505 positioned between the cathode flow field 502 and the anode flow field 504.

In this particular example, the multi-layered membrane 505 includes a plurality of membrane layers (i.e., 506, 508, 510). While three membrane layers are depicted, the multi-layered membrane may include n layers, wherein n is an integer greater than or equal to 3 (i.e., 3, 4, 5, 6, 7, 8, 9, and so on.) In this example, a first membrane layer 506 is positioned adjacent to the cathode flow field 502 and an n^{th} membrane layer 510 positioned adjacent to the anode flow field 504. An additional membrane layer 508 is represented as an intermediate membrane layer positioned between the outer first membrane layer 506 and the outer n^{th} membrane layer 510. Each membrane layer of the multi-layered membrane may have a same or different composition from each additional membrane layer.

Similar to the examples above, a catalyst coating layer and/or GDL 512 may be positioned between the cathode flow field 502 and first membrane layer 506. Additionally, a catalyst coating layer and/or PTL 514 may be positioned between the n^{th} membrane layer 510 and anode flow field 504.

In this example, the multi-layered membrane 505 may include or may not include an intermediate coating layer positioned between two adjacent membrane layers (e.g., such as described in the alternative embodiments of FIGS. 2 and 4). While FIG. 5 does not depict such an intermediate coating layer, one may be present between the first membrane layer 506 and the second membrane layer 508 and/or between one or more adjacent layers between the second membrane layer 508 and the nth membrane layer 510.

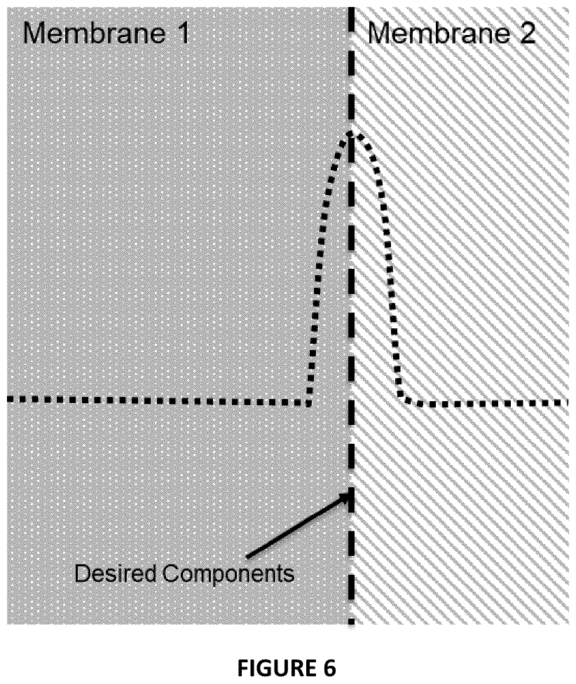

FIG. 6 depicts an example of an arrangement wherein the overall membrane includes two membrane layers with a coating composition layer positioned between the two layers. The two membrane layers are the same or have similar properties in comparison to the coating layer positioned between the two membrane layers. As depicted within the figure, the coating layer advantageously positions the desired components (e.g., radical scavenger composition and/or hydrogen-crossover mitigation catalyst) within the center of the overall membrane, therein providing a spike in the concentration profile of these desired components in the middle of the overall membrane.

The membrane compositions within the first and second membrane layers may be any known or later developed composition. In certain examples, the membrane compositions may be any known or later developed cation or proton exchange membrane (PEM) composition. In some examples, the PEM composition is a pure polymer membrane or a composition membrane having materials embedded within a polymer matrix. One example of a PEM composition is a fluoropolymer composition such as a perfluorosulfonic (PFSA) polymer (e.g., Nafion™).

In other examples, the membrane compositions may be any known or later developed anion exchange material (AEM) configured to conduct anions while being impermeable to gases such as oxygen or hydrogen.

The membrane compositions may include (e.g., organic or inorganic) ion-exchange materials and/or polymers. Certain polymer compositions include hydrophobic polymers such as polystyrene, polyethylene, polysulfone, or combinations thereof. In other examples, the membrane compositions include inorganic compositions such as clay, zeoloites, mineral species, or combinations thereof.

In some examples, the first membrane layer may be different from (i.e., have a different composition from) the second membrane layer. In certain examples, the first and second layers may be made from compositions or materials within a same class. That is, the first and second layers may be different, but within a same class of materials having similar properties. For example, the first and second membrane layers may both be PEM compositions or AEM compositions.

In alternative examples, the first membrane layer may have a PEM or AEM composition, while the second membrane layer has the other of the two material compositions.

Having different membrane layers on opposite sides of the coating layer in the multi-layered membrane may be advantageous in allowing for the use of multiple compositions or materials within the membrane. This may allow for a combination of compositions or materials within the layers to provide a broader range of performance properties for the membrane/electrochemical cell. For example, different membrane layers in a multi-layered membrane may allow for designed improvements in electrical and proton transport, hydrogen diffusion, mechanical strength, and/or thermal stability as compared with a single membrane layer composition attempting to provide a best compromise of the various performance properties.

In some examples, the first and second membranes may have different equivalent weights, different pH, and/or different degrees of cross-linking. In certain examples, one membrane may be a fluorine-free material while the other membrane includes a perfluorinated sulfonic acid (PFSA) membrane.

In certain cases, the agent/catalyst positioned in between two different membrane layers may provide a concentration profile with a step function, wherein the concentration of the agent or catalyst steps up or down at the inner surfaces of two adjoining membrane layers.

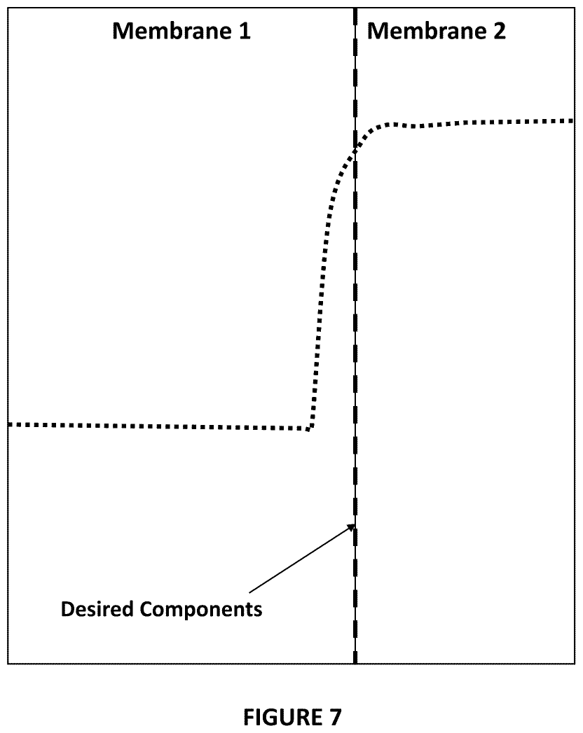

FIG. 7 depicts an example of a multi-layered membrane having different first and second membrane layers and a coating layer positioned between the two membranes. In this example, the first membrane has a lower concentration of a desired component within the membrane material than within the second membrane. Between the two membranes, the coating layer includes the desired composition such as a radical scavenger composition and/or a hydrogen-crossover mitigation catalyst. Additionally, the second membrane includes a similar concentration of the desired composition within the membrane material. This advantageously provides a step function in concentration between the two membrane layers of an overall membrane, providing the desired performance properties of the composition within the coating layer and second membrane while avoiding undesired interaction with the electrode reaction mechanisms adjacent to the first membrane.

Alternative configurations are possible for a step function between two membranes, such as a step down in concentration between the agent/composition/catalyst from the first to the second membrane.

### Methods of Making

Various processes may be employed to create a multi-layered membrane.

In one permutation, the method of forming a multi-layered membrane may include the preparation and formation of an anode-side of the membrane, a separate preparation and formation of a cathode-side of the membrane, and then a joining together of the two sides of the multi-layered membrane.

For example, the assembly of the membrane may include providing a first membrane layer configured to be positioned adjacent to the cathode or hydrogen side of the electrolytic cell. A cathode catalyst coating composition may be subsequently adhered or deposited onto a surface of the first membrane layer that would be adjacent to the cathode of the cell. In some examples, a gas diffusion layer (GSL) may subsequently be adhered to the cathode catalyst coating composition.

The assembly of the multi-layered membrane includes a separate arrangement that could be conducted prior to, at the same time as, or after the first membrane formation described above. In this separate arrangement, a second membrane layer is provided. The second membrane layer is configured to be positioned adjacent to the anode or oxygen side of the electrolytic cell. An anodic catalyst coating composition may be subsequently adhered or deposited onto a surface of the second membrane layer that would be adjacent to the anode of the cell. In some examples, a porous transport layer (PTL) may subsequently be adhered to the anodic catalyst coating composition.

The method further includes providing at least one coating composition or layer, as described above. The coating composition may be applied to a surface of either the first membrane or the second membrane. In some examples, the coating composition may be applied to surfaces of both the first and second membranes. In other examples, one coating composition may be applied to a surface of the first membrane and a second, different coating composition may be applied to a surface of the second membrane.

In any of these scenarios, the coating composition is applied to an inward facing surface of the membrane that is opposite from the electrode (anode or cathode) and on an opposite surface from the GDL or PTL or anodic or cathodic catalyst coating compositions described above.

Following application of the coating composition to one or both membranes, the two membranes are adhered together along with an optional ionomer solution such that the coating composition is positioned between the two membranes. A non-limiting example of such an ionomer solution may include a dispersion of a perfluorosulfonic (PFSA) polymer such as Nafion™ in a solvent such as isopropanol. Such a solution is commercially available as Nafion™ D2020 ionomer dispersion. An advantage of using such a solution in this example is that it may provide improved adherence between the two membranes in comparison to a formulation having two membranes bonded together via an intermediate coating layer alone. Additionally, the ionomer solution may continue to provide continuity for hydrogen ion transport versus other adhesive layers or materials that could undesirably block hydrogen ion transport within the electrochemical cell. In other words, the ionomer solution behaves like a glue while becoming part of the membrane network upon drying (in contrast to a glue or adhesive of a dissimilar molecular composition that may potentially block ion transport).

As noted above, this is advantageous in providing a concentration profile that has a peak in the concentration of a selected agent or catalyst within the membrane (e.g., at the middle of the overall membrane), wherein the agent/catalyst is protected by the adjacent membrane layers and is not directly exposed to the reactant components on either outer surface of the membrane.

In another permutation of forming a multi-layered membrane, the method may include beginning with a substrate layer on one side of the membrane or cell and subsequently adding each additional layer of the multi-layered membrane or cell on top of the existing formation.

For example, this process could include providing one of the electrodes (e.g., the anode or cathode) as the substrate. The method would then continue by applying each layer (or a group of pre-formed layers) to the substrate in order. This could include applying a porous transport layer (PTL) to the anode substrate. This may be followed by the application of an anodic catalyst composition to the exposed PTL surface. This may subsequently be followed by the application of a membrane of the multi-layered membrane to the anodic catalyst composition/PTL/anode substrate. Subsequently, the coating composition(s) may be applied to the exposed surface of the membrane.

In this sequential process, the second membrane would be applied to the formed arrangement, followed by any cathodic catalyst composition, gas diffusion layer, and ending with the adhering of the opposing cathode to complete the cell formation.

In another permutation of forming a multi-layered membrane, the process may include providing a first membrane layer. This first membrane layer may have already been adhered to the anode or cathode at the start of this process or may be conducted at the start of this process as a preliminary act. Further, the first membrane layer may already include any intermediate layers between the anode or cathode (e.g., a catalyst coating layer/GDL/PTL) adhered or positioned on a surface of the first membrane.

The process continues with casting or depositing the second membrane layer/composition onto an exposed surface of the first membrane layer (opposite from any catalyst coating layer/GDL/PTL or electrode attached to the first membrane). This casting or depositing may be conducted by creating a thin layer of ion exchange material from a dispersion (wet) or vapor coating process. The ion exchange material in the second membrane layer may have a different material characteristic from the first membrane layer (e.g., a different EW). In certain examples, this process may include depositing a second membrane composition onto the first membrane layer where the second membrane layer includes the functional enhancement compositions described above (e.g., a radical scavenger agent or a hydrogen-crossover mitigation agent) to create a cell such as depicted in the example of FIG. 3.

Alternatively, in another embodiment, the radical scavenger agent or hydrogen-crossover mitigation agent may be deposited in an intermediate coating layer onto the first membrane layer prior to the casting or depositing of the second membrane layer to create a cell such as depicted in the example of FIG. 2.

Additional or alternative methods of formation are also possible to create such a multi-layered membrane, as long as the end result is the inclusion of a coating composition or layer between two adjacent membranes.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

As used herein, the singular forms “a,” “an,” and “the” include plural referents unless the context clearly dictates otherwise.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the disclosure. The claims should not be read as limited to the described order or elements unless stated to that effect. Therefore, all embodiments that come within the scope and spirit of the following claims and equivalents thereto are claimed as the disclosure.

1. A multi-layered membrane for an electrochemical cell, the multi-layered membrane comprising:
a first membrane layer; and
a second membrane layer,
wherein the first membrane layer is an outer membrane layer configured to be positioned adjacent to a porous transport layer or gas diffusion layer within the electrochemical cell, and
wherein the multi-layered membrane comprises a radical scavenger composition and/or a hydrogen crossover mitigation catalyst positioned within the first membrane layer.

2. The multi-layered membrane of claim 1, wherein the radical scavenger composition is positioned within the first membrane layer.

3. The multi-layered membrane of claim 1, wherein the hydrogen crossover mitigation catalyst is positioned within the first membrane layer.

4.-6. (canceled)

7. The multi-layered membrane of claim 1, wherein the radical scavenger composition is configured to scavenge radicals within an oxygen evolution reaction within the electrochemical cell.

8. The multi-layered membrane of claim 1, wherein the radical scavenger composition comprises catalytic nanoparticles, cerium oxide, or manganese oxide.

9. (canceled)

10. The multi-layered membrane of claim 1, wherein the hydrogen crossover mitigation catalyst is configured to minimize hydrogen crossover from a hydrogen side of the electrochemical cell to an oxygen side of the electrochemical cell.

11. The multi-layered membrane of claim 1, wherein the hydrogen crossover mitigation catalyst comprises platinum.

12.-14. (canceled)

15. The multi-layered membrane of claim 1, further comprising:
at least one additional membrane layer.

16.-26. (canceled)

27. A method of forming a multi-layered membrane for an electrochemical cell, the method comprising:
providing a first membrane layer; and
casting or depositing a second membrane composition onto a surface of the first membrane layer to form a second membrane layer adjacent to the first membrane layer,
wherein the first membrane layer and the second membrane layer comprise different compositions, and
wherein the second membrane layer comprises a radical scavenger composition and/or a hydrogen crossover mitigation catalyst positioned within the second membrane layer,
wherein the second membrane layer is an outer membrane layer of the multi-layered membrane configured to be positioned adjacent to a porous transport layer or gas diffusion layer within the electrochemical cell.

28. The method of claim 27, wherein the radical scavenger composition is configured to scavenge radicals within an oxygen evolution reaction within the electrochemical cell.

29. The method of claim 27, wherein the radical scavenger composition comprises catalytic nanoparticles, cerium oxide, or manganese oxide.

30. (canceled)

31. The method of claim 27, wherein the hydrogen crossover mitigation catalyst is configured to minimize hydrogen crossover from a hydrogen side of the electrochemical cell to an oxygen side of the electrochemical cell.

32. The method of claim 27, wherein the hydrogen crossover mitigation catalyst comprises platinum.

33. An electrochemical cell comprising:
an anode flow field;
a cathode flow field;
a multi-layered membrane positioned between the anode flow field and the cathode flow field;
a porous transport layer positioned between the anode flow field and the multi-layered membrane; and
a gas diffusion layer positioned between the cathode flow field and the multi-layered membrane,
wherein the multi-layered membrane comprises:
a first membrane layer; and
a second membrane layer,
wherein the first membrane layer is an outer membrane layer positioned adjacent to the porous transport layer or the gas diffusion layer, and
wherein the multi-layered membrane includes a radical scavenger composition and/or a hydrogen crossover mitigation catalyst positioned within the first membrane layer.

34. The electrochemical cell of claim 33, wherein the radical scavenger composition is positioned within the first membrane layer.

35. The electrochemical cell of claim 33, wherein the hydrogen crossover mitigation catalyst is positioned within the first membrane layer.

36.-38. (canceled)

39. The electrochemical cell of claim 33, wherein the radical scavenger composition is configured to scavenge radicals within an oxygen evolution reaction within the electrochemical cell.

40. The electrochemical cell of claim 33, wherein the radical scavenger composition comprises catalytic nanoparticles, cerium oxide, or manganese oxide.

41. (canceled)

42. The electrochemical cell of claim 33, wherein the hydrogen crossover mitigation catalyst is configured to minimize hydrogen crossover from a hydrogen side of the electrochemical cell to an oxygen side of the electrochemical cell.

43. The electrochemical cell of claim 33, wherein the hydrogen crossover mitigation catalyst comprises platinum.

44.-47. (canceled)
